(19) United States
(12) Patent Application Publication
(10) Pub. No.: US 2026/0088688 A1
(43) Pub. Date: Mar. 26, 2026

(54) ROTOR MANUFACTURING APPARATUS

(71) Applicant: TOYOTA BOSHOKU KABUSHIKI KAISHA, Aichi-ken (JP)

(72) Inventors: Yuki WAKIMOTO, Tokai-shi (JP); Masaki SUGIYAMA, Okazaki-shi (JP)

(73) Assignee: TOYOTA BOSHOKU KABUSHIKI KAISHA, Aichi-ken (JP)

(21) Appl. No.: 19/319,858

(22) Filed: Sep. 5, 2025

(30) Foreign Application Priority Data
Sep. 20, 2024 (JP) 2024-163947

(51) Int. Cl. H02K 15/121; H02K 15/035

(52) U.S. Cl. CPC H02K 15/121; H02K 15/035; H02K 2215/00

(57) ABSTRACT

A rotor manufacturing apparatus is configured to manufacture a rotor that includes a tubular rotor core having multiple slots, multiple magnets respectively accommodated in the slots, and multiple pieces of plastic fixing the magnets to the rotor core. The rotor manufacturing apparatus includes plungers configured to extrude the plastic toward the slots, and a drive unit configured to be movable toward and away from the rotor core. The drive unit includes accommodating portions and an urging section. The accommodating portions respectively receive the plungers such that the plungers are movable relative to the accommodating portions in a movement direction of the drive unit. The urging section urges the plungers in an extrusion direction of the plastic from inside the accommodating portions.

### CROSS-REFERENCE TO RELATED APPLICATIONS

This application is based upon and claims the benefit of priority from Japanese Patent Application No. 2024-163947, filed on Sep. 20, 2024, the entire contents of which are incorporated herein by reference.

### BACKGROUND

### 1. Field

The present disclosure relates to a rotor manufacturing apparatus.

### 2. Description of Related Art

JP2022-116745A discloses a manufacturing apparatus for a rotor (referred to as a “core unit” in the publication), which is a component of a rotating electric machine. The rotor includes an iron core body having multiple magnet insertion holes, multiple permanent magnets inserted into the respective magnet insertion holes, and multiple pieces of plastic filler respectively filling the magnet insertion holes.

The manufacturing apparatus described in the publication includes a lower die, an upper die having receiving holes, an auxiliary plate having plastic flow passages, and extrusion portions. The lower die supports a jig, on which the iron core body is placed, from below. The auxiliary plate is placed on the upper surface of the iron core body. The upper die sandwiches the jig, the iron core body, and the auxiliary plate together with the lower die. The extrusion portions are configured to be integrally movable in the vertical direction by a single drive source. The extrusion portions uniformly extrude multiple pieces of plastic, which have been supplied to the receiving holes of the upper die, toward the magnet insertion holes, thereby filling, with the plastic, the magnet insertion holes through the plastic flow passages of the auxiliary plate.

In order to achieve uniform filling volumes of plastic across the multiple magnet insertion holes, it is desirable for the plastic supplied to the respective receiving holes to have uniform volumes. However, the volumes of the plastic may vary.

In the manufacturing apparatus described in the above publication, the extrusion portions are moved integrally by the single drive source, resulting in identical displacement among the extrusion portions. Consequently, when the volume of a piece of the plastic exceeds a desired volume, overfilling into the corresponding magnet insertion hole may occur, which may cause the plastic to leak outside of the filling path. Therefore, in rotor manufacturing, it is desirable to prevent plastic from overfilling of the magnet insertion holes.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a rotor manufacturing apparatus is configured to manufacture a rotor including a tubular rotor core having multiple slots extending therethrough in an axial direction, multiple magnets respectively accommodated in the slots, and multiple pieces of plastic respectively filling the slots to fix the magnets to the rotor core. The rotor manufacturing apparatus includes multiple plungers configured to extrude the multiple pieces of the plastic toward the slots, and a drive unit configured to support the plungers and to be movable toward and away from the rotor core. The drive unit includes multiple accommodating portions that respectively receive the plungers such that the plungers are movable in a movement direction of the drive unit relative to the accommodating portions, and an urging section that urges the plungers from inside the accommodating portions in an extrusion direction in which the plastic is extruded.

Other features and aspects will be apparent from the following detailed description, the drawings, and the claims.

### BRIEF DESCRIPTION OF THE DRAWINGS

FIG. 1 is a perspective view showing a rotor according to a first embodiment.

FIG. 2 is a cross-sectional view of the rotor shown in FIG. 1.

FIG. 3 is a cross-sectional view illustrating a rotor manufacturing apparatus according to the first embodiment.

FIG. 4 is a cross-sectional view showing a state in which the intermediate plate shown in FIG. 3 is in contact with a caul plate.

FIG. 5 is a cross-sectional view showing a state in which the fixed die and the movable die shown in FIG. 3 are clamped.

FIG. 6 is a cross-sectional view showing a state in which the plunger unit shown in FIG. 3 has filled slots with plastic.

FIG. 7 is a cross-sectional view illustrating a rotor manufacturing apparatus according to a second embodiment.

FIG. 8 is a plan view showing the base portion shown in FIG. 7.

FIG. 9 is a cross-sectional view showing a state in which the plunger unit shown in FIG. 7 has filled slots with plastic.

FIG. 10 is a plan view showing a base portion according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

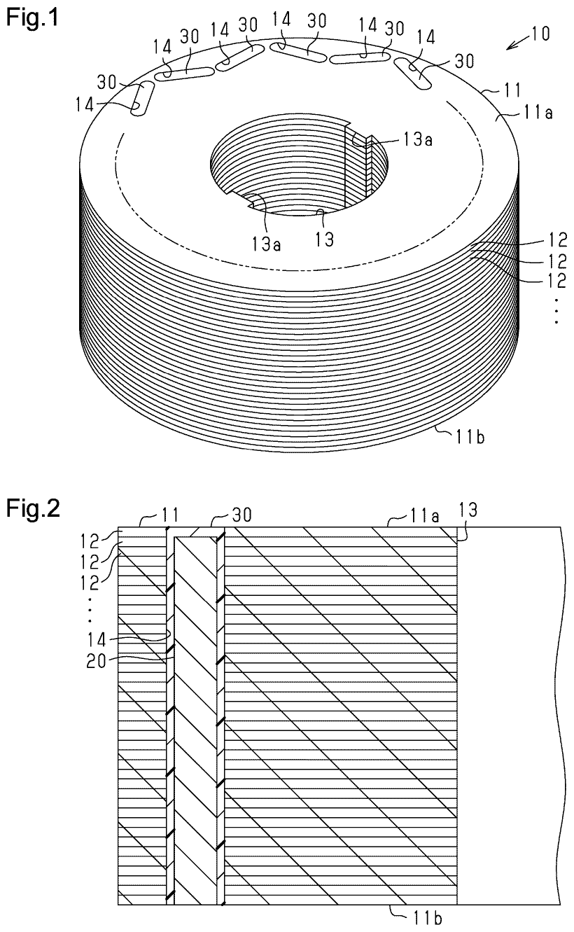

A rotor manufacturing apparatus according to a first embodiment will now be described with reference to FIGS. 1 to 6.

First, a rotor 10 manufactured by the rotor manufacturing apparatus (hereinafter, referred to as a manufacturing apparatus 40) of the present embodiment will be described.

### Configuration of the Rotor 10

As shown in FIG. 1, the rotor 10 includes a rotor core 11, multiple magnets 20, and multiple pieces of plastic 30. The rotor 10 is used in, for example, a magnet-embedded motor.

The rotor core 11 is substantially cylindrical. The rotor core 11 is formed, for example, by stacking iron core pieces 12 that are punched out from a magnetic steel sheet.

In the following description, the axial direction of the rotor core 11 will simply be referred to as an axial direction. The radial direction of the rotor core 11 will simply be referred to as a radial direction. The circumferential direction of the rotor core 11 will simply be referred to as a circumferential direction.

The rotor core 11 includes a first end face 11a and a second end face 11b, which are located on opposite sides in the axial direction.

The rotor core 11 includes a center hole 13 and slots 14. A shaft (not shown) is inserted into the center hole 13. The slots 14 are formed in the outer circumferential portion of the rotor core 11 at intervals in the circumferential direction. The center hole 13 and the slots 14 extend through the rotor core 11 in the axial direction. In other words, the center hole 13 and the slots 14 both open in the first end face 11a and the second end face 11b.

The center hole 13 is substantially circular in plan view. Two protruding keys 13a, which are opposed to each other in the radial direction, are provided on the inner surface of the center hole 13. The keys 13a are fitted into keyways provided in the shaft (not shown) to restrict relative movement between the rotor core 11 and the shaft in the circumferential direction.

The cross-sectional shape of each slot 14 orthogonal to the axial direction is a substantially rectangular shape having long sides and short sides. The cross-sectional shape of each slot 14 is constant over the entire length in the axial direction.

The magnets 20 are, for example, permanent magnets. Each slot 14 receives one of the magnets 20. The magnets 20 are fixed to the rotor core 11 by the plastic 30 filling the slots 14.

As shown in FIG. 2, each magnet 20 has a shape elongated in the axial direction. The dimension of each magnet 20 in the axial direction is shorter than the dimension of the rotor core 11 in the axial direction. Each magnet 20 has a substantially rectangular cross section orthogonal to the axial direction.

One end face in the axial direction of each magnet 20 is located, for example, inward of the first end face 11a in the axial direction. The other end face of each magnet 20 on the opposite side in the axial direction from the one end face is, for example, flush with the second end face 11b.

The plastic 30 is, for example, a thermosetting plastic. The plastic 30 fills, for example, the entire circumference of each magnet 20 between the inner surface of the slot 14 and the outer surface of the magnet 20. The plastic 30 covers one end face in the axial direction of the magnet 20 and is flush with the first end face 11a of the rotor core 11.

### Overall Configuration of the Manufacturing Apparatus 40

The configuration of the manufacturing apparatus 40 will now be described.

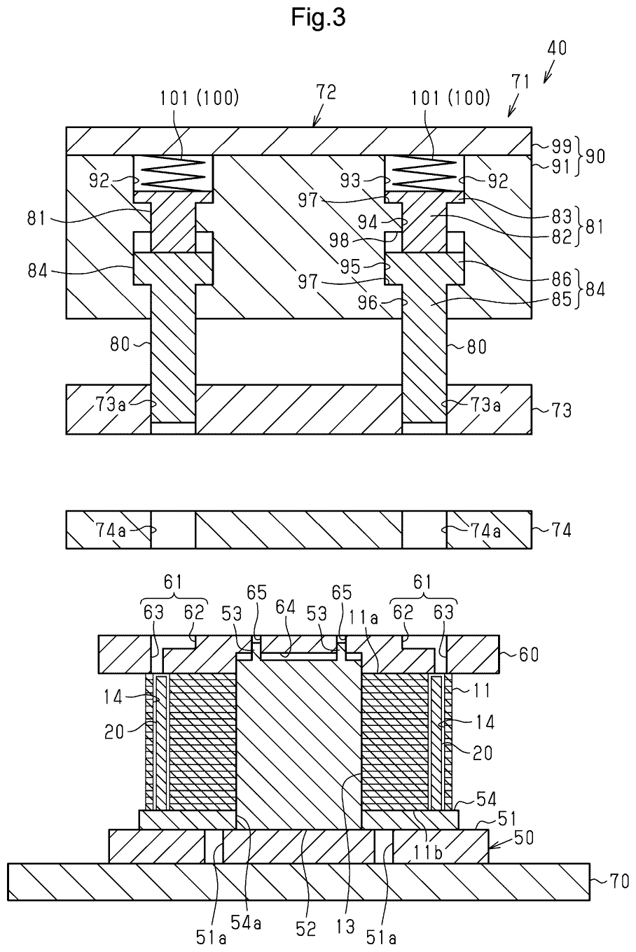

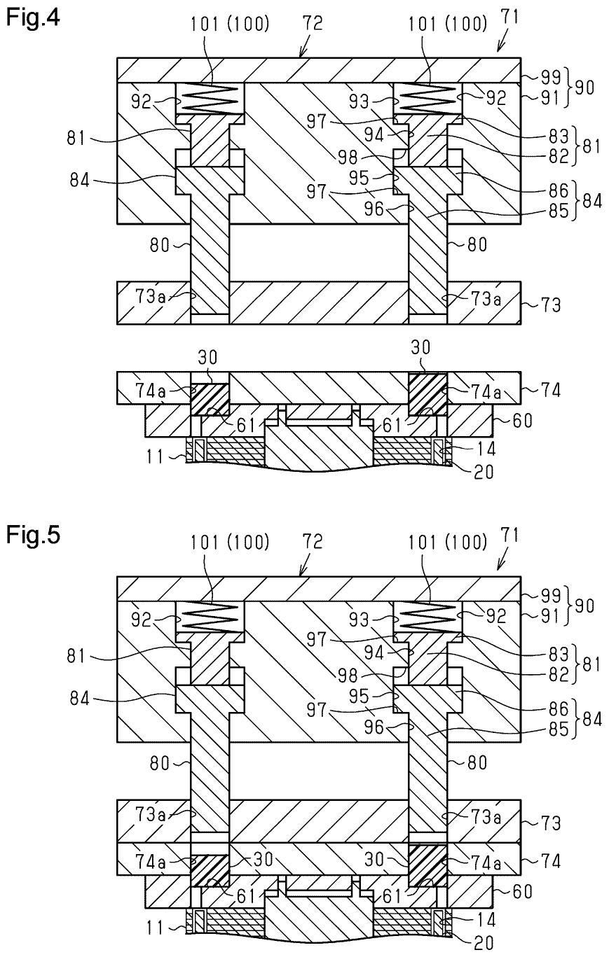

As shown in FIG. 3, the manufacturing apparatus 40 is configured to fill each slot 14 of the rotor core 11 with the plastic 30 (see FIG. 4) and solidify the plastic 30. The manufacturing apparatus 40 includes a support jig 50, a caul plate 60, a fixed die 70, and a movable die 71.

The support jigs 50 support the second end face 11b of the rotor core 11 from below. The caul plate 60 is disposed on the first end face 11a of the rotor core 11. The fixed die 70 supports the support jig 50 from below. The movable die 71 is disposed above the fixed die 70. The movable die 71 is configured to be moved toward and away from the fixed die 70 in the vertical direction. The fixed die 70 and the movable die 71 are configured to be clamped to sandwich the support jig 50, the rotor core 11, and the caul plate 60 in the axial direction, that is, in the vertical direction.

### Configuration of the Support Jig 50

The support jig 50 includes a base plate 51, a post 52, and a spacer 54. The base plate 51 is flat. The post 52 protrudes upward from a central portion of the base plate 51. The spacer 54 is stacked on the upper surface of the base plate 51 and supports the second end face 11b of the rotor core 11.

The base plate 51 has multiple through-holes 51a extending therethrough in the thickness direction. The through-holes 51a are provided at intervals so as to surround the post 52.

The post 52 has a columnar shape. The post 52 extends through the spacer 54. The post 52 is inserted into the center hole 13 of the rotor core 11. The post 52 includes keyways (not shown) in the outer circumferential surface. The keyways are engaged with the keys 13a of the rotor core 11 (see FIG. 1). When the keys 13a are engaged with the keyways, the rotor core 11 is positioned relative to the support jig 50. The post 52 includes multiple positioning pins 53 on the distal end face.

The spacer 54 has the shape of a flat plate. The spacer 54 has a center hole 54a into which the post 52 is inserted. Although not illustrated, the spacer 54 is configured to be raised and lowered along the post 52 by a lift mechanism that moves up and down through the through-holes 51a of the base plate 51. The rotor core 11 is removed from the support jig 50 by raising the spacer 54 in relation to the post 52.

### Configuration of the Caul Plate 60

The caul plate 60 includes multiple filling pots 61 provided in correspondence with the slots 14. Pellets of the plastic 30 are disposed in the filling pots 61 (see FIG. 4).

The filling pots 61 each include a runner portion 62 and a conduit hole 63. The runner portion 62 opens in the upper surface of the caul plate 60. The conduit hole 63 opens in the bottom surface of the runner portion 62 and extends through the caul plate 60 in the thickness direction. The conduit hole 63 connects the runner portion 62 to the corresponding slot 14.

The caul plate 60 includes a recess 64 and positioning holes 65. The recess 64 opens in the lower surface of the central portion of the caul plate 60. The positioning holes 65 open in the ceiling surface of the recess 64 and extend through the caul plate 60 in the thickness direction.

The recess 64 receives the distal end of the post 52. The positioning pins 53 of the post 52 are inserted into the positioning holes 65. By inserting the positioning pins 53 into the positioning holes 65, the position of the caul plate 60 is determined relative to the support jig 50 and the rotor core 11. Accordingly, the filling pots 61 and the slots 14 are connected to each other.

### Configuration of the Movable Die 71

The movable die 71 includes a plunger unit 72, a pressure plate 73, and an intermediate plate 74.

### Configuration of the Plunger Unit 72

The plunger unit 72 includes multiple plungers 80 and a drive unit 90. The plunger unit 72 includes the same number of plungers 80 as the number of filling pots 61. The drive unit 90 is configured to support the plungers 80 and to be moved toward and away from the rotor core 11. The plungers 80 move toward and away from the rotor core 11 together with the drive unit 90. The plungers 80 are pressed against the plastic 30 by the drive unit 90, thereby extruding the pieces of the plastic 30 arranged in the filling pots 61 of the caul plate 60 toward the slots 14. The plungers 80 have identical shapes and dimensions.

Each plunger 80 includes a first pin 81 and a second pin 84 coupled to the lower end of the first pin 81. The first pin 81 and the second pin 84 are disposed coaxially.

The first pin 81 includes a first body portion 82 and a first flange 83. The first body portion 82 has a columnar shape extending in the vertical direction. The first flange 83 is formed at the upper end of the first body portion 82 and radially enlarged relative to the outer circumference of the first body portion 82.

The second pin 84 includes a second body portion 85 and a second flange 86. The second body portion 85 has a columnar shape extending in the vertical direction. The second body portion 85 is longer than the first body portion 82 in the vertical direction. The second flange 86 is formed at the upper end of the second body portion 85 and radially enlarged relative to the outer circumference of the second body portion 85. The lower end of the first body portion 82 is coupled to the second flange 86.

The drive unit 90 includes a base portion 91 and a cover 99. The base portion 91 includes multiple accommodating portions 92, which respectively receive the plungers 80 such that the plungers 80 are vertically movable in the movement direction of the drive unit 90 relative to the accommodating portions 92. The accommodating portions 92 extend in the vertical direction through the base portion 91. The cover 99 is fixed to the upper surface of the base portion 91 so as to cover the upper openings of the accommodating portions 92.

Each accommodating portion 92 includes, in coaxial arrangement, a first large-diameter portion 93, a first small-diameter portion 94, a second large-diameter portion 95, and a second small-diameter portion 96. The cross-sectional shapes of the first large-diameter portion 93, the first small-diameter portion 94, the second large-diameter portion 95, and the first small-diameter portion 94 are circular. The accommodating portions 92 have identical shapes and dimensions.

The first large-diameter portion 93 is open in the upper surface of the base portion 91. The first large-diameter portion 93 accommodates the first flange 83 of the first pin 81. The diameter of the first large-diameter portion 93 is substantially the same as the diameter of the first flange 83. The dimension in the vertical direction of the first large-diameter portion 93 is larger than the dimension in the vertical direction of the first flange 83.

The first small-diameter portion 94 communicates with a lower portion of the first large-diameter portion 93. The first body portion 82 of the first pin 81 is accommodated in the first small-diameter portion 94. The diameter of the first small-diameter portion 94 is smaller than the diameter of the first large-diameter portion 93 and is substantially the same as the diameter of the first body portion 82. The dimension in the vertical direction of the first small-diameter portion 94 is smaller than the dimension in the vertical direction of the first body portion 82.

The second large-diameter portion 95 communicates with a lower portion of the first small-diameter portion 94. The second large-diameter portion 95 accommodates the second flange 86 of the second pin 84. The diameter of the second large-diameter portion 95 is larger than the diameter of the first small-diameter portion 94 and is substantially the same as the diameter of the second flange 86. The diameter of the second large-diameter portion 95 is, for example, the same as the diameter of the first large-diameter portion 93. The dimension in the vertical direction of the second large-diameter portion 95 is larger than the dimension in the vertical direction of the second flange 86.

The second small-diameter portion 96 communicates with a lower portion of the second large-diameter portion 95 and opens in the lower surface of the base portion 91. The second small-diameter portion 96 accommodates the second body portion 85 of the second pin 84. The diameter of the second small-diameter portion 96 is smaller than the diameter of the second large-diameter portion 95 and is substantially the same as the diameter of the second body portion 85. The diameter of the second small-diameter portion 96 is, for example, the same as the diameter of the first small-diameter portion 94. The dimension in the vertical direction of the second small-diameter portion 96 is smaller than the dimension in the vertical direction of the second body portion 85. The second body portion 85 extends downward from the second small-diameter portion 96 and projects below the lower surface of the base portion 91.

The accommodating portion 92 includes a support portion 97 that supports the plunger 80 from below. The support portion 97 is defined by the bottom wall of the first large-diameter portion 93, in which the first small-diameter portion 94 opens, and the bottom wall of the second large-diameter portion 95, in which the second small-diameter portion 96 opens. The bottom wall of the first large-diameter portion 93 contacts the first flange 83 from below. The bottom wall of the second large-diameter portion 95 contacts the second flange 86 from below. Accordingly, the plunger 80 is supported by the drive unit 90.

The drive unit 90 includes an urging section 100 that urges the plungers 80 in the extrusion direction of the plastic 30 from within the accommodating portions 92. The urging section 100 includes multiple compression coil springs 101 accommodated in the respective accommodating portions 92. The compression coil springs 101 have the same spring constant. The compression coil springs 101 are accommodated in the first large-diameter portions 93. The upper end of each compression coil spring 101 is in contact with the lower surface of the cover 99. The lower end of each compression coil spring 101 is in contact with the upper surface of the corresponding first flange 83.

The urging section 100 presses each first flange 83 against the bottom wall of the corresponding first large-diameter portion 93, that is, against the support portion 97. In addition, the urging section 100 presses each second flange 86 against the bottom wall of the corresponding second large-diameter portion 95, that is, against the support portion 97.

Each accommodating portion 92 includes a restricting portion 98. When the plunger 80 moves relative to the drive unit 90 in a direction opposite to the extrusion direction of the plastic 30, the restricting portion 98 restricts the relative movement of the plunger 80 by coming into contact with the plunger 80 from the side opposite to the extrusion direction. The restricting portion 98 includes the ceiling wall of the second large-diameter portion 95, in which the first small-diameter portion 94 opens. That is, when the plunger 80 and the drive unit 90 move relative to each other, the ceiling wall of the second large-diameter portion 95 and the second flange 86 come into contact with each other in the vertical direction, thereby restricting the relative movement. In the present embodiment, the drive unit 90 moves downward relative to the plungers 80 pressed against the plastic 30, while compressing the compression coil springs 101. This causes the plungers 80 and the drive unit 90 to move relative to each other. Therefore, each restricting portion 98 comes into contact with the corresponding plunger 80 from above when the drive unit 90 moves downward with respect to the plunger 80.

### Configuration of the Pressure Plate 73

The pressure plate 73 is disposed below the drive unit 90. The pressure plate 73 is coupled to the plunger unit 72 so as to be movable in the vertical direction relative to the plunger unit 72. A die clamping force for clamping the fixed die 70 and the movable die 71 is applied to the pressure plate 73. The pressure plate 73 has multiple first through-holes 73a into which the plungers 80 are respectively inserted. The first through-holes 73a extend through the pressure plate 73 in the thickness direction.

### Configuration of the Intermediate Plate 74

The intermediate plate 74 is disposed below the pressure plate 73. The intermediate plate 74 is coupled to the pressure plate 73 so as to be movable relative to the pressure plate 73 in the vertical direction.

The intermediate plate 74 includes multiple second through-holes 74a into which the plungers 80 are respectively inserted. The second through-holes 74a extend through the intermediate plate 74 in the thickness direction. The second through-holes 74a are provided at positions corresponding to the first through-holes 73a.

The plastic 30 disposed in each filling pot 61 of the caul plate 60 is accommodated in the corresponding second through-hole 74a (see FIG. 5). Each second through-hole 74a communicates with the corresponding slot 14 via the corresponding filling pot 61 of the caul plate 60 when the fixed die 70 and the movable die 71 are clamped.

### Manufacturing Procedure of the Rotor 10

Next, a manufacturing procedure of the rotor 10 using the manufacturing apparatus 40 will be described.

As shown in FIG. 3, when the rotor 10 is manufactured, first, the magnets 20 are accommodated in the slots 14 of the rotor core 11 supported by the support jig 50.

Next, the caul plate 60 is placed on the first end face 11a of the rotor core 11. At this time, the positioning pins 53 are inserted into the positioning holes 65.

Next, the support jig 50, the rotor core 11, and the caul plate 60 are preheated to a specified temperature by placing the support jig 50 in a heating device (not shown). Further, the fixed die 70 and the movable die 71 are preheated to a specified temperature.

Next, the support jig 50, the rotor core 11, and the caul plate 60 are disposed between the fixed die 70 and the movable die 71.

Then, as shown in FIG. 4, the movable die 71 is lowered, so that the intermediate plate 74 comes into contact with the upper surface of the caul plate 60.

Thereafter, pellets of the plastic 30 are disposed in the respective filling pots 61 through the second through-holes 74a. The plastic 30 disposed in the filling pots 61 is melted by the heat from the preheating.

Next, as shown in FIG. 5, the plunger unit 72 and the pressure plate 73 are lowered, so that the pressure plate 73 comes into contact with the upper surface of the intermediate plate 74. This applies a die clamping force to the pressure plate 73. Accordingly, the fixed die 70 and the movable die 71 are clamped to sandwich the support jig 50, the rotor core 11, and the caul plate 60 in the vertical direction.

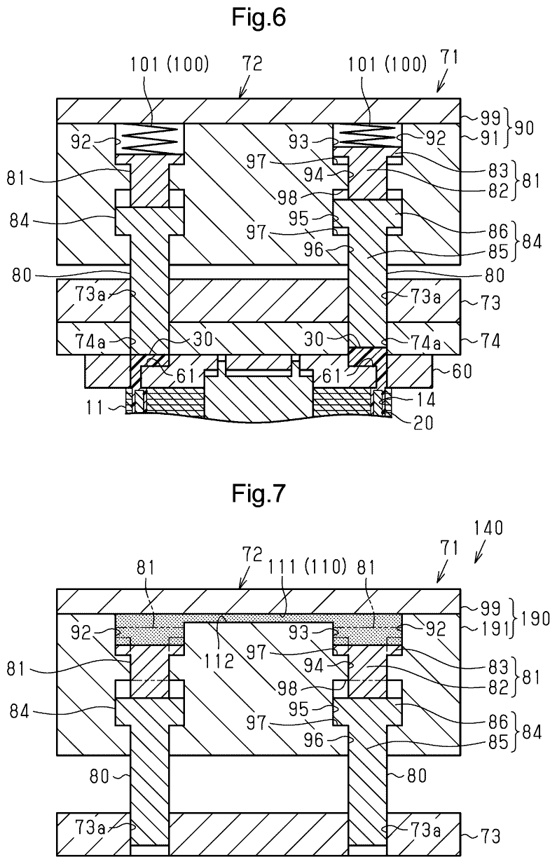

Next, as shown in FIG. 6, the plunger unit 72 is lowered, so that each plunger 80 is pressed against the plastic 30 in a molten state. At this time, when the force with which the drive unit 90 presses the plungers 80 against the plastic 30 reaches a specified threshold, the drive unit 90 descends with respect to the plungers 80 against the urging force of the urging sections 100, i.e., the urging force of the compression coil springs 101. This separates the first flanges 83 and the second flanges 86 of the plungers 80 from the respective support portions 97. The plastic 30 is pressurized inside the filling pots 61 by the plungers 80, so that the slots 14 are filled with the plastic 30 via the filling pots 61. The plastic 30 filling the slots 14 is solidified by being heated by the heat from the preheating. The magnets 20 are thus fixed to the rotor core 11.

Next, the fixed die 70 and the movable die 71 are opened, so that the movable die 71 is separated from the caul plate 60. Then, the caul plate 60 is taken out of the manufacturing apparatus 40, and the rotor 10 is removed from the support jig 50.

The rotor 10 is manufactured in the above-described manner.

### Operation and Advantages of the Present Embodiment

(1-1) The manufacturing apparatus 40 includes the plungers 80 and the drive unit 90. The plungers 80 extrude the plastic 30 toward the slots 14. The drive unit 90 is configured to support the plungers 80 and to be moved toward and away from the rotor core 11. The drive unit 90 includes the accommodating portions 92 and the urging section 100. The accommodating portions 92 respectively receive the plungers 80 such that the plungers 80 are movable relative to the accommodating portions 92 in the movement direction of the drive unit 90. The urging section 100 urges the plungers 80 in the extrusion direction of the plastic 30 from the inside of the accommodating portions 92.

According to this configuration, when the drive unit 90 moves toward the rotor core 11, each plunger 80 is pressed against the plastic 30. As a result, the plastic 30 is extruded toward the slots 14, so that the plastic 30 fills the slots 14. Each plunger 80 is accommodated in the corresponding accommodating portion 92 so as to be movable relative to the drive unit 90 in the movement direction of the drive unit 90, and is urged in the extrusion direction by the urging section 100 from the inside the accommodating portion 92. Therefore, when the force with which the drive unit 90 presses the plungers 80 against the plastic 30 reaches the specified threshold, the plungers 80 and the accommodating portions 92 move relative to each other in the movement direction. Thus, the amounts of relative movement of the plungers 80 with respect to the accommodating portions 92 vary depending on the volume of the plastic 30. Consequently, the amount of the plastic 30 supplied to each slot 14 by the corresponding plunger 80 is adjusted according to the volume of the plastic 30. This prevents overfilling of the plastic 30 into the slots 14.

(1-2) The urging section 100 includes the multiple compression coil springs 101 accommodated in the respective accommodating portions 92.

According to this configuration, since the compression coil spring 101 is accommodated in each accommodating portion 92, it is possible to embody the urging section 100 with a simple configuration.

(1-3) Each accommodating portion 92 includes the restricting portion 98. When the plunger 80 moves relative to the accommodating portion 92 in a direction opposite to the extrusion direction, the restricting portion 98 restricts the relative movement of the plunger 80 by coming into contact with the plunger 80 from the side opposite to the extrusion direction.

According to this configuration, when the plunger 80 is pressed against the plastic 30 and thus moves relative to the drive unit 90 in the direction opposite to the extrusion direction of the plastic 30, the restricting portion 98 restricts the movement of the plunger 80 relative to the drive unit 90. As a result, the amount of compression of the compression coil spring 101 accommodated in the accommodating portion 92 is limited, so that excessive compression of the compression coil spring 101 is avoided. This prevents deterioration of the compression coil spring 101.

### Second Embodiment

A rotor manufacturing apparatus 140 according to a second embodiment will now be described with reference to FIGS. 7 to 9. Differences from the first embodiment will mainly be discussed.

The same reference numerals are given to those components in the second embodiment that are the same as the corresponding components of the first embodiment, and redundant explanations are omitted.

As shown in FIG. 7, the manufacturing apparatus 140 of the second embodiment is different from that of the first embodiment in the configuration of an urging section 110. The manufacturing procedure of the rotor 10 using the manufacturing apparatus 140 is the same as that of the first embodiment.

The urging section 110 includes a single oil chamber 111 that applies hydraulic pressure to the plungers 80. The oil chamber 111 is formed inside a drive unit 190. The oil chamber 111 is filled with oil.

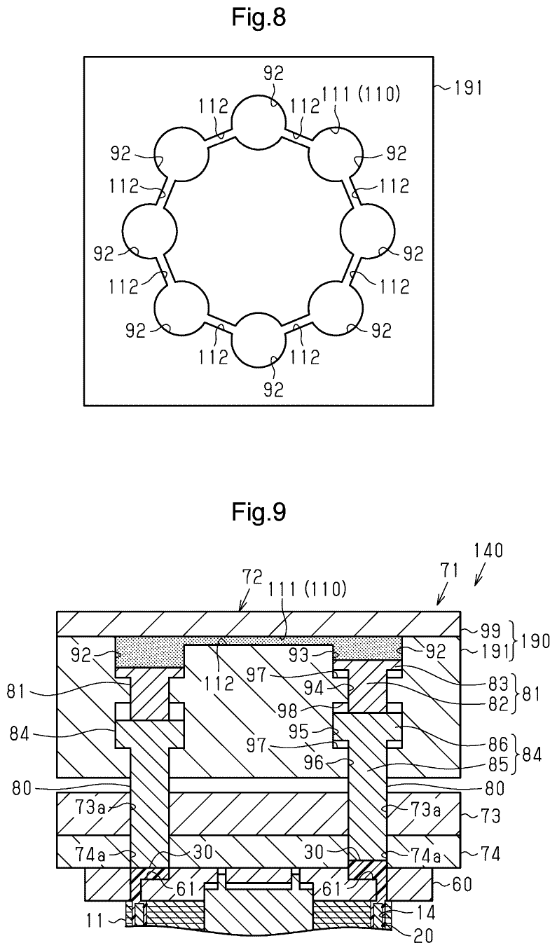

As shown in FIG. 8, the oil chamber 111 includes accommodating portions 92 and connecting passages 112 that connect the accommodating portions 92 to each other. The accommodating portions 92 are arranged in a circular shape in the base portion 191. Each of the connecting passages 112 extends in a straight line and connects two accommodating portions 92 adjacent to each other in the circumferential direction. The connecting passages 112 have identical shapes and dimensions.

As shown in FIG. 7, each connecting passage 112 has the shape of a groove that opens in the upper surface of the base portion 191. Each of the connecting passages 112 connects two of the first large-diameter portions 93 that are adjacent to each other in the circumferential direction. The opening of the oil chamber 111, that is, the openings of the accommodating portions 92 and the connecting passages 112 are closed by the cover 99. The oil chamber 111 is sealed without communicating with the outside of the drive unit 190.

As indicated by the long-dash double-short-dash lines in FIG. 7, each connecting passage 112 is positioned such that, when the corresponding plungers 80 are in contact with the restricting portions 98, the ends of the plungers 80 on the side opposite to the extrusion direction are spaced apart from the connecting passages 112 in the extrusion direction. In other words, the connecting passages 112 are positioned above the first pins 81 in a state in which the second flanges 86 of the second pins 84 are in contact with the restricting portions 98.

A seal member (not shown) for suppressing leakage of oil from the oil chamber 111 is provided between the upper surface of the base portion 191 and the lower surface of the cover 99. Also, a seal member (not shown) is provided between the outer circumferential surface of each first pin 81 and the inner circumferential surface of the corresponding accommodating portion 92.

As shown in FIG. 9, when the force with which the drive unit 190 presses the plungers 80 against the plastic 30 reaches a specified threshold, the drive unit 190 descends with respect to the plungers 80 against the urging force of the urging section 110, that is, the force based on the hydraulic pressure of the oil chamber 111. This separates the first flanges 83 and the second flanges 86 of the plungers 80 from the respective support portions 97.

### Operation and Advantages of the Present Embodiment

(2-1) The urging section 110 includes the single oil chamber 111 that applies hydraulic pressure to the plungers 80. The oil chamber 111 includes the accommodating portions 92 and the connecting passages 112 that connect the accommodating portions 92 to each other.

According to this configuration, the multiple plungers 80 are urged by the single oil chamber 111. This allows the urging force acting on the plungers 80 to be easily adjusted. This readily prevents overfilling of the plastic 30 into the slots 14.

(2-2) Each accommodating portion 92 includes the restricting portion 98. When the plunger 80 moves relative to the accommodating portion 92 in a direction opposite to the extrusion direction, the restricting portion 98 restricts the relative movement of the plunger 80 by coming into contact with the plunger 80 from the side opposite to the extrusion direction. Each connecting passage 112 is positioned such that, when the corresponding plungers 80 are in contact with the restricting portions 98, the ends of the plungers 80 on the side opposite to the extrusion direction are spaced apart from the connecting passages 112 in the extrusion direction.

According to this configuration, when the plungers 80 are pressed against the plastic 30 and thus move relative to the drive unit 190 in the direction opposite to the extrusion direction of the plastic 30, the restricting portions 98 restrict the movement of the plungers 80 relative to the drive unit 190. Each connecting passage 112 is positioned such that, when the corresponding plungers 80 are in contact with the restricting portions 98, the ends of the plungers 80 on the side opposite to the extrusion direction are spaced apart from the connecting passages 112 in the extrusion direction. Therefore, when the plungers 80 come into contact with the restricting portions 98, the connecting passage 112 is prevented from being blocked by the plungers 80. This prevents the function of the urging section 110 from being impaired.

### Modifications

The above-described embodiments may be modified as follows. The above-described embodiments and the following modifications can be combined as long as the combined modifications remain technically consistent with each other.

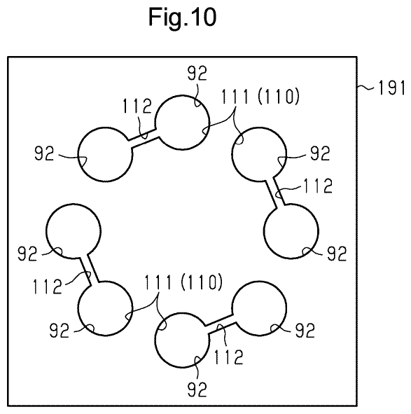

In the second embodiment, as shown in FIG. 10, the urging section 110 may include multiple oil chambers 111, each of which applies hydraulic pressure to at least two of the multiple plungers 80. In this case, each oil chamber 111 includes at least two of the accommodating portions 92 and at least one of the connecting passages 112 that connects the at least two accommodating portions 92 to each other. According to this configuration, since the plungers 80 accommodated in the at least two of the accommodating portions 92 are urged by the common oil chamber 111, the urging force acting on the at least two of the plungers 80 can be easily adjusted.

In the second embodiment, in addition to the urging section 110, which includes the oil chamber 111 for applying hydraulic pressure to at least two of the plungers 80, the drive unit 190 may include the urging section 100 of the first embodiment as a configuration for urging the remaining plungers 80.

In the second embodiment, the urging section 110 may urge the plungers 80 using pneumatic pressure instead of hydraulic pressure.

Each accommodating portion 92 may omit the restricting portion 98. In this case, in the first embodiment, it is preferable to set a movable range of the drive unit 90 so as to avoid excessive compression of the compression coil springs 101. In the second embodiment, it is preferable to set a movable range of the drive unit 190 such that the connecting passages 112 are not blocked by the plungers 80.

In the first embodiment, the urging section 100 may include multiple leaf springs or multiple gas springs instead of the compression coil springs 101.

In each of the embodiments, the plunger unit 72 may include a smaller number of the plungers 80 than the number of the slots 14. In this case, for example, each filling pot 61 may have multiple conduit holes 63 communicating with two or more of the slots 14.

In each of the embodiments, the plunger unit 72 may be configured to fill the slots 14 with the plastic 30 by approaching the rotor core 11 from below.

In any of the embodiments, the plastic 30 may be a thermoplastic.

In each of the embodiments, the support portion 97 may be formed by either the bottom wall of the first large-diameter portion 93 or the bottom wall of the second large-diameter portion 95.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A rotor manufacturing apparatus configured to manufacture a rotor including a tubular rotor core having multiple slots extending therethrough in an axial direction, multiple magnets respectively accommodated in the slots, and multiple pieces of plastic respectively filling the slots to fix the magnets to the rotor core, the rotor manufacturing apparatus comprising:
multiple plungers configured to extrude the multiple pieces of the plastic toward the slots; and
a drive unit configured to support the plungers and to be movable toward and away from the rotor core, the drive unit including:
multiple accommodating portions that respectively receive the plungers such that the plungers are movable in a movement direction of the drive unit relative to the accommodating portions; and
an urging section that urges the plungers from inside the accommodating portions in an extrusion direction in which the plastic is extruded.

2. The rotor manufacturing apparatus according to claim 1, wherein the urging section includes multiple compression coil springs respectively accommodated in the accommodating portions.

3. The rotor manufacturing apparatus according to claim 2, wherein each accommodating portion includes a restricting portion, wherein, when the plungers move relative to the drive unit in a direction opposite to the extrusion direction, each restricting portion restricts movement of the corresponding plunger relative to the accommodating portion by coming into contact with the plunger from a side opposite to the extrusion direction.

4. The rotor manufacturing apparatus according to claim 1, wherein
the urging section includes an oil chamber that applies hydraulic pressure to at least two of the plungers, and
the oil chamber includes:
at least two of the accommodating portions; and
a connecting passage that connects the at least two of the accommodating portions to each other.

5. The rotor manufacturing apparatus according to claim 4, wherein
the urging section includes a single oil chamber that applies hydraulic pressure to the plungers,
the connecting passage is one of multiple connecting passages, and
the oil chamber includes the accommodating portions and the connecting passages that connect the accommodating portions to each other.

6. The rotor manufacturing apparatus according to claim 4, wherein
each accommodating portion includes a restricting portion, wherein, when the plungers move relative to the drive unit in a direction opposite to the extrusion direction, each restricting portion restricts movement of the corresponding plunger relative to the accommodating portion by coming into contact with the plunger from a side opposite to the extrusion direction, and
each connecting passage is positioned such that, when the corresponding plungers are in contact with the restricting portions, ends of the plungers on the side opposite to the extrusion direction are spaced apart from the connecting passages in the extrusion direction.
